(19) United States
(12) Patent Application Publication
(10) Pub. No.: US 2026/0349435 A1
(43) Pub. Date: Nov. 5, 2026

(54) ROBOT OPERATION PLANNING METHOD AND SYSTEM, AND USE THEREOF

(71) Applicant: HUIZHI ROBOT TECHNOLOGY (SHENZHEN) CO., LTD., Shenzhen, Guangdong (CN)

(72) Inventors: Yuanbin WANG, Shenzhen, Guangdong (CN); Fanglong LUO, Shenzhen, Guangdong (CN); Hehao PAN, Shenzhen, Guangdong (CN); Shaoqiang XU, Shenzhen, Guangdong (CN); Zhaoxian CHEN, Shenzhen, Guangdong (CN)

(73) Assignee: HUIZHI ROBOT TECHNOLOGY (SHENZHEN) CO., LTD., Shenzhen, Guangdong (CN)

(21) Appl. No.: 19/120,661

(22) PCT Filed: Apr. 16, 2024
(86) PCT No.: PCT/CN2024/087853

§ 371 Date: Apr. 11, 2025

(30) Foreign Application Priority Data
May 17, 2023 (CN) 202310553626.4

(51) Int. Cl. G05D 1/622; G05D 1/648; G05D 105/00; G05D 105/10; G05D 105/15; G05D 105/80

(52) U.S. Cl. CPC G05D 1/622; G05D 1/648; G05D 2105/10; G05D 2105/12; G05D 2105/15; G05D 2105/80

(57) ABSTRACT

The present application provides a robot operation planning method and system, and use thereof. The method includes: determining a surface awaiting operation; starting a manual mode, controlling an operation robot to perform a manual operation from a starting point, and continuously recording path information and environmental information during an operation process of the operation robot; starting an automatic mode, fitting an enclosed area of any shape based on the path information and the environmental information, and determining a safety boundary and an automatic operation path; enabling the operation robot to perform an automatic operation within the safety boundary according to the automatic operation path until an operation covering the enclosed area is completed; and checking an operation effect and an area coverage effect.

### CROSS REFERENCE TO RELATED APPLICATION

The present application is a national stage application of International Patent Application No. PCT/CN2024/087853, filed on Apr. 16, 2024, which claims priority to Chinese Patent Application No. 202310553626.4 filed to the China National Intellectual Property Administration (CNIPA) on May 17, 2023 and entitled “ROBOT OPERATION PLANNING METHOD AND SYSTEM, AND USE THEREOF”, which is incorporated herein by reference in its entirety.

### TECHNICAL FIELD

The present disclosure relates to the field of robot operation planning, and specifically, to a robot operation planning method and system, and use thereof.

### BACKGROUND

In contemporary industry, a robot refers to an artificial machine apparatus that can automatically perform tasks to replace or assist human labor. Generally, it is an electromechanical apparatus controlled by computer programs or electronic circuits. Robots are designed to replace or assist humans in tasks such as those in manufacturing, construction, or hazardous environments.

With the development of robotics technology, the applications of robots across various industries and scenarios are becoming increasingly widespread. Fully autonomous mobile robots (which require no human intervention in any scenario, akin to autonomous driving Level 5) have always been the ideal standard in robotics development. The goal is to achieve complete human-like adaptability to the environment, with autonomous cognition, obstacle avoidance, planning, and navigation, aiming for seamless operation in a variety of environments.

To adapt to different complex scenarios and ensure safety, more investments are required in areas such as environmental perception, intelligent algorithms, and map annotation for fully autonomous mobile robots. This has resulted in high initial research, development, and application costs. Moreover, during operation, robots need to continuously perceive complex scenarios, avoid obstacles, and prevent falls, which significantly impacts the operating speed. Furthermore, the implementation of perception and obstacle-avoidance algorithms relies on hardware support, with higher-end robots requiring more advanced hardware. As a result, current robotic technologies face challenges such as interference, loss of positioning, sensor noise, unstable recognition, and sensor blind spots, making it impossible to guarantee absolute safe operation and resulting in performance far below expectations.

To ensure coverage and effectiveness in operations, robots typically need to perform edge-following tasks. Edge-following tasks can be understood as operating close to the edges of the operation area. The closer to the edge, the higher the degree of edge-following. The higher the edge-following degree, the larger the area that the robot can automatically operate in, and the smaller the area requiring secondary manual operation, meaning that the proportion of human intervention is reduced. This is also an important metric for evaluating the effectiveness of automatic operation robots. However, the closer a robot operates to the edge, the closer it is to obstacles or hazardous areas, which introduces greater challenges to perception and obstacle avoidance capabilities. This has become a persistent challenge in the autonomous robotics industry, with no effective solutions currently available.

For automatic robotic operation, it is generally necessary to define the operational area in order to plan the path. This includes creating and editing maps, as well as planning operation areas and operation schemes, collectively referred to as the deployment phase. The deployment phase is critical to automatic robotic operation, as without a map to guide, the robot struggles to perform the automatic operation in a designated area. The deployment phase is often complex and involves tasks such as map creation and path setting.

In the prior art, some solutions use a teaching/playback approach for the robot to complete the deployment phase. This approach needs an operator to demonstrate the complete path, and the robot to learn and replicate the operation path of the operator, aiming to simplify the deployment phase. However, in large operation areas, having the operator fully demonstrate the operation path for the entire area is extremely time-consuming and requires a certain level of skill from the operator. In some cases, the operator can complete the operation manually after the complete demonstration. Therefore, using a teaching method for deployment is inefficient, incurs high labor costs, and makes the deployment phase relatively complex.

### SUMMARY

In view of the shortcomings of the prior art, the present disclosure aims to provide a robot operation planning method and system, and use thereof. Specific solutions are as follows:

According to a first aspect, the present disclosure provides a robot operation planning method, including:
determining a surface awaiting operation and ensuring that a preset operation robot is able to operate safely on the surface awaiting operation;
starting a manual mode, and setting a manual operation starting point and a manual operation ending point on the surface awaiting operation;
controlling the operation robot to perform a preset manual operation from the manual operation starting point, continuously recording path information and environmental information during an operation process of the operation robot until reaching the manual operation ending point, and ending the manual mode;
starting an automatic mode, fitting an enclosed area of any shape based on the path information and environmental information recorded in the manual mode, planning an automatic operation path within the enclosed area, and using a boundary of the enclosed area as a safety boundary;
enabling the operation robot to perform an automatic operation within the safety boundary according to the automatic operation path until an operation covering the enclosed area is completed, and ending the automatic mode; and
checking an operation effect and an area coverage effect of the surface awaiting operation.

In a specific embodiment, after the operation covering the enclosed area is completed, the operation robot is controlled to automatically return to the manual operation ending point or the manual operation starting point, and a user is notified that the automatic operation is completed.

In a specific embodiment, if the operation effect or the area coverage effect of the surface awaiting operation does not meet an expected value, the operation robot is controlled to perform a manual operation.

In a specific embodiment, obstacles on the surface awaiting operation are inferred based on the environmental information recorded in the manual mode, and by combining the safety boundary, the planned automatic operation path avoids the obstacles without entering an area outside the safety boundary.

In a specific embodiment, during the automatic operation, the operation robot detects, through a preset sensing apparatus, whether there are obstacles in a forward direction; and if yes, the operation robot is controlled to automatically avoid the obstacles, and the operation robot always stays within the safety boundary during the obstacle avoidance process.

In a specific embodiment, the operation robot includes a floor cleaning robot, a floor washing robot, a lawn mowing robot, a snow sweeping robot, and an inspection robot.

According to a second aspect, the present disclosure provides a robot operation planning system, including:
a preparation unit configured to determine a surface awaiting operation, and ensure that a preset operation robot is able to operate safely on the surface awaiting operation;
a manual operation unit configured to start a manual mode, and set a manual operation starting point and a manual operation ending point on the surface awaiting operation; and
control the operation robot to perform a preset manual operation from the manual operation starting point, continuously record path information and environmental information during an operation process of the operation robot until reaching the manual operation ending point, and end the manual mode;
an automatic operation unit configured to start an automatic mode, fit an enclosed area of any shape based on the path information and environmental information recorded in the manual mode, plan an automatic operation path within the enclosed area, and use a boundary of the enclosed area as a safety boundary; and
control the operation robot to perform an automatic operation within the safety boundary according to the automatic operation path until an operation covering the enclosed area is completed, and end the automatic mode; and
a detection unit configured to check an operation effect and an area coverage effect of the surface awaiting operation.

In a specific embodiment, the automatic operation unit is further configured to:
after the operation covering the enclosed area is completed, control the operation robot to automatically return to the manual operation ending point or the manual operation starting point, and notify a user that the automatic operation is completed; and/or
during the automatic operation, control the operation robot to detect, through a preset sensing apparatus, whether there are obstacles in a forward direction; and if yes, control the operation robot to automatically avoid the obstacles; and/or
infer obstacles on the surface awaiting operation based on the environmental information recorded in the manual mode, and by combining the safety boundary, ensure that the planned automatic operation path avoids the obstacles without entering an area outside the safety boundary.

In a specific embodiment, the detection unit is further configured to:
if the operation effect or the area coverage effect of the surface awaiting operation does not meet an expected value, control the operation robot to perform a manual operation.

According to a third aspect, the present disclosure provides a cleaning method, adopting the robot operation planning method according to the first aspect, and including:
determining a to-be-cleaned surface and ensuring that a preset cleaning robot is able to safely clean the to-be-cleaned surface;
starting a manual mode, and setting a manual cleaning starting point and a manual cleaning ending point on the to-be-cleaned surface;
controlling the cleaning robot to perform preset manual cleaning from the manual cleaning starting point, continuously recording path information and environmental information during a cleaning process of the cleaning robot until reaching the manual cleaning ending point, and ending the manual mode;
starting an automatic mode, fitting an enclosed area of any shape based on the path information and environmental information recorded in the manual mode, planning an automatic cleaning path within the enclosed area, and using a boundary of the enclosed area as a safety boundary;
controlling the cleaning robot to perform automatic cleaning within the safety boundary according to the automatic cleaning path until cleaning covering the enclosed area is completed, and ending the automatic mode; and
checking a cleaning effect and an area coverage effect of the to-be-cleaned surface.

With the above technical solutions, the present disclosure achieves the following beneficial effects.

The present disclosure provides a robot operation planning method and system, and use thereof. Before the robot performs the automatic operation, the area for the automatic operation is determined based on a work trajectory of the manual operation, implementing an alternative mode of map creation to complete the deployment phase of the robot. Compared to the prior art, this method eliminates the need for specialized and cumbersome deployment processes such as mapping, editing, and path setting, as well as complex operation processes such as task selection, position confirmation, and task initiation, which can fully leverage the advantages of human-robot collaborative operation.

Furthermore, by dividing the safety area, safety boundary, and hazardous area based on the enclosed area manually confirmed for the manual operation, the safety of the automatic operation by the robot is qualitatively ensured, allowing the robot to perform the automatic operation with greater confidence.

The above method clearly defines the safety boundary and hazardous area for the robot. Since the safety boundary partially covers some boundary areas during operation in the manual mode, the robot does not need to operate close to the safety boundary during automatic operation. This skillfully reduces the probability of the robot performing automatic edge-following operations, addressing the industry-wide challenge of edge-following operations and making the automatic operation of the robot safer and more efficient.

### BRIEF DESCRIPTION OF THE DRAWINGS

To describe the technical solutions in the embodiments of the present disclosure or in the prior art more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a robot operation planning method according to an embodiment of the present disclosure;

FIG. 2 is schematic diagram of a boundary of an automatic operation area according to an embodiment of the present disclosure;

FIG. 3 is a schematic diagram of modules of a robot operation planning system according to an embodiment of the present disclosure; and

FIG. 4 is a flowchart of a cleaning method according to an embodiment of the present disclosure.

Reference numerals: 1—preparation unit; 2—manual operation unit; 3—automatic operation unit; and 4—detection unit.

### DETAILED DESCRIPTION

The technical solutions of the embodiments of the present disclosure are clearly and completely described below with reference to the drawings in the embodiments of the present disclosure. Apparently, the described embodiments are merely a part rather than all of the embodiments of the present disclosure. All other examples obtained by a person of ordinary skill in the art based on the examples of the present disclosure without creative efforts shall fall within the protection scope of the present disclosure.

In the description of the present disclosure, it should be noted that orientations or position relationships indicated by terms “upper”, “lower”, “horizontal”, “inner”, “outer”, “top”, “bottom”, etc. are orientations or position relationships as shown in the drawings, and these terms are just used to facilitate description of the present disclosure and simplify the description, but not to indicate or imply that the mentioned apparatus or elements must have a specific orientation and must be established and operated in a specific orientation, and thus, these terms cannot be understood as a limitation to the present disclosure.

In the present disclosure, it should be noted that, unless otherwise clearly specified and limited, the meanings of terms “forming” and “connection” should be understood in a broad sense. For example, the “connection” may be a fixed connection, a removable connection or an integrated connection, and may be a direct connection or an indirect connection via an intermediate medium. A person of ordinary skill in the art may understand specific meanings of the foregoing terms in the present disclosure based on a specific situation.

It should be noted that the automatic operation refers to the operation being completed entirely by the robot autonomously, without requiring additional intervention from an operator. In contrast, the manual operation still involves the robot, but the operator uses the robot to assist in completing the operation, rather than the operation being fully performed manually. Therefore, in the present application, both automatic and manual operations involve the same operation robot.

It should be noted that the operation robot in the present application can essentially be understood as a semi-autonomous robot, which operates in both manual and automatic modes. In the manual mode, the robot can be controlled by a human, much like traditional tools, to perform precise operations that require human intervention. In the automatic mode, the robot can execute tasks independently based on preset programs and algorithms. Semi-autonomous robots are typically used for tasks that require both flexibility and efficiency. In the manual mode, the operator can adjust and intervene as needed to meet different production requirements; in the automatic mode, the robot can perform tasks at higher speeds and with greater precision, thus improving production efficiency and product quality. It is important to distinguish semi-autonomous robots from fully autonomous robots, as fully autonomous robots can only operate in the automatic mode, whereas semi-autonomous robots offer greater flexibility and customization, being suitable for a wider range of production needs.

It should be noted that the safety boundary in the present application refers to a boundary that the robot cannot exceed. Even if the robot needs to perform automatic obstacle avoidance during automatic operation, the robot cannot surpass the safety boundary. The enclosed area is constructed based on an operation path in the manual mode of the operation robot. Generally speaking, the enclosed area does not include an area in which the robot has already completed an operation in the manual operation mode, but is defined by the boundary of the area. Therefore, the boundary of the enclosed area (that is, the safety boundary) has reserved space for the safety of the operation robot.

The present disclosure is described in further detail below with reference to specific implementations.

### Embodiment 1

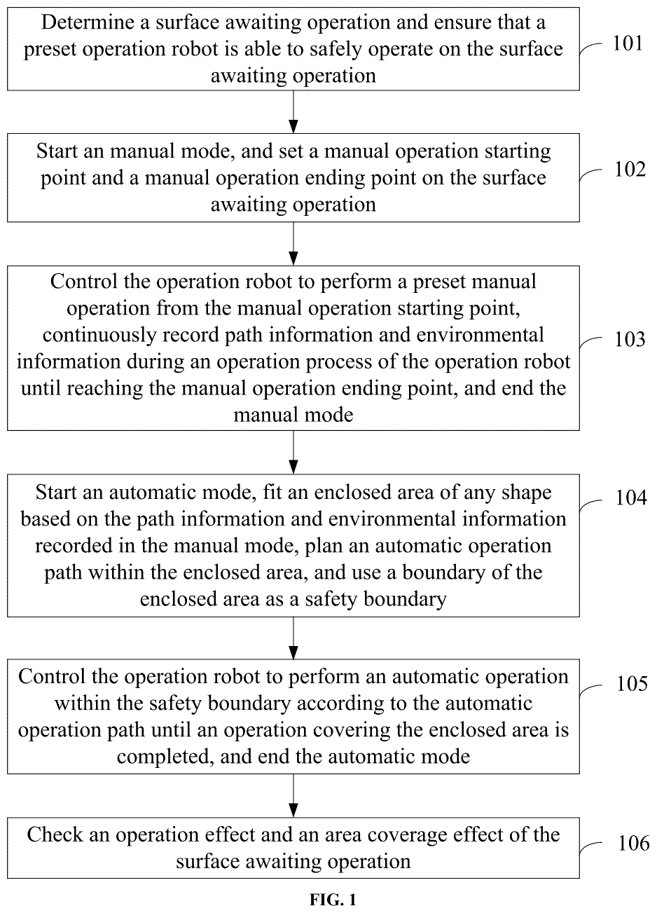

Embodiment 1 of the present disclosure discloses a robot operation planning method, which fully utilizes the coordination relationship between tasks in the work areas. Before a robot performs an automatic operation, working trajectories of other tasks are used to create area information, thereby maximizing the advantages of both manual and automatic operations. A specific procedure is shown in FIG. 1. The specific solutions are as follows:

A robot operation planning method includes the following steps:
101: Determine a surface awaiting operation and ensure that a preset operation robot is able to operate safely on the surface awaiting operation.
102: Start an manual mode, and set a manual operation starting point and a manual operation ending point on the surface awaiting operation.
103: Control the operation robot to perform a preset manual operation from the manual operation starting point, continuously record path information and environmental information during an operation process of the operation robot until reaching the manual operation ending point, and end the manual mode.
104: Start an automatic mode, fit an enclosed area of any shape based on the path information and environmental information recorded in the manual mode, plan an automatic operation path within the enclosed area, and use a boundary of the enclosed area as a safety boundary.
105: Control the operation robot to perform an automatic operation within the safety boundary according to the automatic operation path until an operation covering the enclosed area is completed, and end the automatic mode.
106: Check an operation effect and an area coverage effect of the surface awaiting operation.

The robot operation planning method provided in this embodiment presents an innovative solution for the deployment phase of the robot. By seeking a balance between the manual operation and the automatic operation, this method ensures the robot operation efficiency while using the manual operation to replace the deployment phase and cover most of the edge operation areas. This approach decreases the complexity and cost of the deployment phase, reduces the robot reliance on functions such as perception and obstacle avoidance, and achieves seamless coordination between the two modes, fully leveraging the advantages of both the manual operation and the automatic operation.

First, the surface awaiting operation is determined, and it is ensured that the preset operation robot can safely operate on the surface awaiting operation. The surface awaiting operation is an area, which can be any polygonal enclosed area. This area involves both automatic and manual operations, and the boundary of the automatic operation is unknown and needs to be defined through manual operation. Thus, the manual and automatic operations are in a collaborative relationship. The operation robot is a core device responsible for operation execution. During the manual operation, an operator controls the operation robot to participate in the operation, while during the automatic operation, the robot independently performs the operation without human involvement.

During operation, the robot needs to collaborate with humans or other robots, so the robot safety must be ensured. In practical applications, the surface awaiting operation often contains factors that are unfavorable for operation, such as large obstacles or hazardous materials. Therefore, in the step 101, it is necessary to remove unsafe factors on the surface awaiting operation, to ensure the operation robot can operate safely. This is achieved by equipping various sensors to detect the surrounding environment and avoid collisions with other objects or safety incidents.

The manual mode is started, and the manual operation starting point and the manual operation ending point are set on the surface awaiting operation. A goal of the manual operation is to define the boundary for the automatic operation, and the operator needs to control the operation robot to delineate the boundary. Therefore, the starting point and the ending point need to be set in advance. Preferably, the manual operation starting point and the manual operation ending point are at the same location.

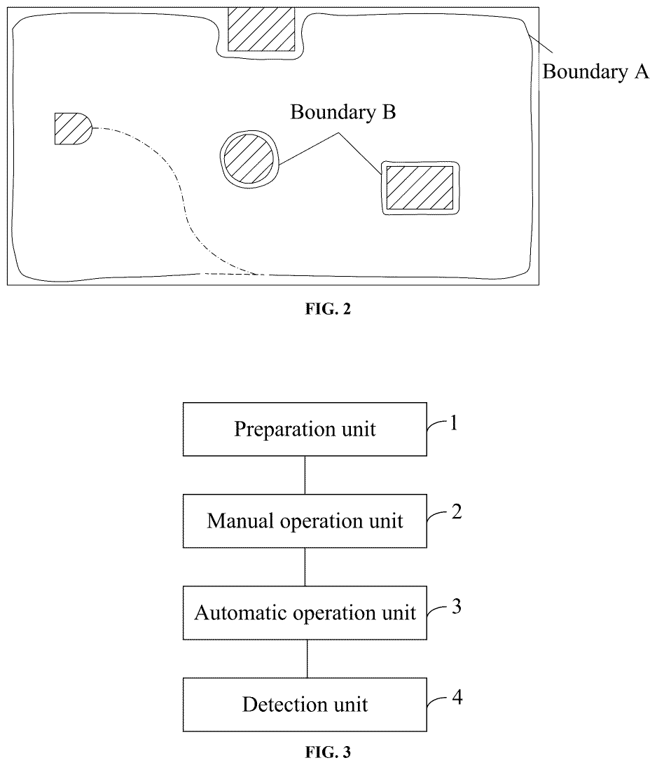

When the manual operation starting point and the manual operation ending point are the same, a movement trajectory of the operation robot can define a complete and closed boundary line, and the area enclosed by the boundary line is directly used as the area for the automatic operation of the operation robot. However, in some special scenarios, the manual operation starting point and the manual operation ending point cannot be the same. In such cases, a complete and closed area cannot be enclosed, and instead, an algorithm is used to fit a line between the manual operation starting point and the manual operation ending point. This line, combined with the movement trajectory of the operation robot, is then used as the area for the automatic operation of the operation robot, as shown in FIG. 2. In FIG. 2, a boundary A represents the safety boundary, and the area within the safety boundary is an area that has been manually verified as safe for the operation robot to perform the automatic operation. Areas outside of the boundary A are all dangerous areas, which the operation robot should not enter. The circular and square obstacles in the figure are objects that the operation robot needs to automatically avoid during the automatic operation. A boundary B is not a safety boundary, as the safety boundary refers to the boundary of the enclosed area.

Subsequently, the operation robot is controlled to perform the preset manual operation from the manual operation starting point, the path information and the environmental information are continuously recorded during the operation process of the operation robot until reaching the manual operation ending point, and the manual mode is ended. The operator can move the operation robot to the manual operation starting point by pushing, driving, or remote control, and then proceed with the manual operation. During the manual operation, the operator needs to control movement of the operation robot, to reach the ending point smoothly.

The manual operation mode refers to the operator manually controlling movement of the operation robot. The operator can control the operation robot to operate or simply control the operation robot to move without operation, depending on the specific application scenario. In other words, in the automatic operation mode, the operation robot performs an operation related to a first operation type; in the manual operation mode, the robot performs an operation related to a second operation type. The first and second operation types may be the same or different.

For example, the surface awaiting operation is a whole piece of farmland to be harvested, a first robot is an automatic harvester, and an operation type is harvesting of specific crops. The edges of the farmland often have complex environments, and direct automatic harvesting may lead to accidents. By using the robot operation planning method of this embodiment, before automatic harvesting, the automatic harvester can be driven to harvest the crops at the edges of the farmland, thereby defining the boundary for the automatic harvesting. Then, the automatic harvester is controlled to automatically harvest crops within the boundary, which not only ensures the automatic harvesting efficiency of the automatic harvester, but also well handles the edges of the farmland.

During manual operation, the path information and the environmental information of the operation robot are recorded. The path information refers to the movement trajectory of the operation robot. The whole robot can be considered as a point, and the movement trajectory of the point is recorded. The environmental information can be detected using a detection module such as an ultrasonic apparatus or a radar apparatus, to detect obstacles around the path. Alternatively, an image collection unit such as a camera apparatus can be used to capture images around the path, so as to analyze the surrounding obstacles or other environmental factors. For example, during movement of the operation robot, the radar apparatus and the camera apparatus are used for monitoring in real-time. A control system determines obstacles around the robot according to data fed back by the radar apparatus, and avoids the obstacles in subsequent path planning. Then computer vision or machine learning techniques are used to analyze and recognize the obstacles. In practical applications, different operation robots operate in different environments, such that it is necessary to set specific environmental information according to a specific operation environment, and then select a detection tool to detect the environmental information. For example, if there is a high-temperature area in a scenario, a temperature sensor can be integrated to detect the temperature around the path, and areas with excessively high temperature are avoided in subsequent path planning.

Collection of the environmental information and the path information can be achieved using a combination of multiple collection schemes, and can also be linked to a module relevant to automatic obstacle avoidance. For example, the path information and the environmental information are collected through a detection module relevant to automatic obstacle avoidance. Based on the environmental information recorded in the manual mode, the obstacles on the surface awaiting operation are inferred, and the planned automatic operation path avoids the obstacles without exceeding the safety boundary, thus realizing the automatic obstacle avoidance of the operation robot during the automatic operation.

The automatic mode is started, an enclosed area of any shape is fitted based on the path information and the environmental information recorded in the manual mode, the automatic operation path is planned within the enclosed area, and the boundary of the enclosed area is used as the safety boundary. Automatic operation refers to the operation robot automatically operating without human involvement, and this does not include necessary operations such as parameter setting and maintenance in the early stage, and implies a reduced level of human involvement in the automatic mode compared to that in the manual mode. In other words, the automatic operation in this embodiment refers to the automatic operation that can be achieved by the operation robot in the conventional sense, and the degree of the automatic operation depends on the degree of automation of the operation robot.

Based on the path information recorded in the manual mode, the enclosed area of any shape is fitted. The area is set by the operator through the operation robot in advance, which is equivalent to completing the mapping phase. For example, during the movement, position coordinate information and direction information of the operation robot can be recorded. The position coordinate information of the operation robot is transformed into point coordinates in a planar coordinate system. A current position can be obtained through the sensor on the robot, or Global Positioning System (GPS) or other positioning devices mounted on the robot. According to the direction information of the robot, the orientation angle of the robot during movement can be calculated. For example, if the direction of the robot is due north, the orientation angle is 0 degrees. By connecting the recorded point coordinates in the order of movement, a path representing the movement trajectory of the robot can be obtained.

Under normal circumstances, the manual operation starting point and the manual operation ending point are the same, and an area with a complete and closed boundary line can be directly fitted according to the trajectory. However, when there is a big difference between the manual operation starting point and the manual operation ending point, the operation robot needs to fit the boundary autonomously. The operator can preset the fitting method on the operation robot in advance. For example, the simplest way is connecting the manual operation starting point and the manual operation ending point to obtain a straight line, and combining the straight line with the trajectory to obtain an enclosed area. Alternatively, a complex approach may involve adjusting on the basis of the straight line, analyzing whether there are obstacles between the manual operation starting point and the manual operation ending point, then fitting and adjusting a curve, and combining the curve with the trajectory to obtain an enclosed area. An algorithm can be used to convert obtained line segments into a polygon to represent the boundary line of the enclosed area. Commonly used algorithms include a convex hull algorithm and a Laplacian smoothing algorithm. These algorithms can connect each corner of the line segments, to form an enclosed polygon. Finally, the enclosed area can be trimmed and smoothed to remove unnecessary edge points and noise points, resulting in an enclosed boundary line for autonomous navigation and obstacle avoidance of the robot within the area.

It should be noted that in practical application, the movement trajectory of the robot may be affected by environmental interference and errors. Therefore, real-time monitoring and correction are necessary when setting the boundary line, to improve the accuracy and stability of the boundary line.

According to the environmental information, the obstacles in the enclosed area can be analyzed, and the obstacle factors are considered during path planning to ensure the obstacle avoidance effect. In addition, during the automatic operation, the operation robot is controlled to detect, through the preset sensing apparatus, whether there are obstacles in the forward direction; and if yes, the operation robot is controlled to automatically avoid the obstacles. During automatic obstacle avoidance, the operation robot does not exceed the safety boundary and always moves within the safety boundary.

The sensing apparatus includes a laser radar, an ultrasonic sensor, a visual sensor, or an infrared sensor. These sensors can detect the position, shape, distance and size of the obstacles. The control system receives information sent by the sensor and calculates the action that the robot needs to take. For example, if the robot detects an obstacle ahead, the control system calculates whether the robot needs to turn left or right, or slow down and stop. In actual operation, the control system can record the type, position, and movement pattern of the obstacles encountered by the robot. The control system can use the data to continuously optimize the obstacle avoidance strategy of the robot to improve the performance and stability of the robot. Achieving automatic obstacle avoidance requires considering factors such as the accuracy, response speed, and working distance of the sensor, and tuning and optimizing the control system to ensure that the robot can effectively avoid obstacles in different environments.

During the automatic operation of the operation robot, the operator can engage in other jobs. The operation robot only needs to perform the automatic operation according to the automatic operation path until the operation covering the enclosed area is completed, and the automatic mode is ended.

Under normal circumstances, the automatic operation path autonomously completed by the operation robot completely covers the enclosed area, thereby completing the operation in this area. However, considering scenarios such as automatic obstacle avoidance and hardware failures, there may be areas that the operation cannot cover. In this case, it is necessary to detect the completion status of the automatic operation of the operation robot.

Indicators for assessing the completion status include the operation effect and the area coverage effect. If the operation effect or the area coverage effect of the surface awaiting operation does not meet the expected value, the operation robot is controlled to perform the manual operation. The operation effect refers to whether the operation robot can accomplish the preset operation, and the area coverage effect refers to the proportion of the area covered by the automatic operation of the operation robot in relation to the entire surface awaiting operation or the enclosed area. After the operation covering the enclosed area is completed, the operation robot is controlled to automatically return to the manual operation ending point or the manual operation starting point, and the user is notified that the automatic operation is completed.

The operation planning method for the operation robot in this embodiment can be applied to various service robots. Preferably, the operation robot includes a floor cleaning robot, a floor washing robot, a lawn mowing robot, a snow sweeping robot, and an inspection robot. These robots provide a wide range of services to humans, including cleaning, maintenance, inspection, security, medical care and so on. Service robots can be used in various occasions, such as homes, hospitals, factories, and public spaces, to improve productivity, reduce costs, and enhance the quality of life.

This embodiment provides a robot operation planning method. Before the robot performs the automatic operation, the area for the automatic operation is determined based on the work trajectory of the manual operation, implementing an alternative mode of map creation to complete the deployment phase of the robot. Compared to the prior art, this method eliminates the need for specialized and cumbersome deployment processes such as mapping, editing, and path setting, as well as complex operation processes such as task selection, position confirmation, and task initiation. It allows for the coverage of most edge operation areas, enhancing the edge operation capability of the robot while ensuring safety. This method fully leverages the advantages of human-robot collaborative operation.

### Embodiment 2

Embodiment 2 of the present disclosure discloses a robot operation planning system, which systematizes the robot operation planning method of Embodiment 1, making it more practical. The overall structural diagram of the robot operation planning system is shown in FIG. 3 of the specification, and the specific solutions are as follows:

A robot operation planning system includes:
a preparation unit 1 configured to determine a surface awaiting operation and ensure that a preset operation robot is able to operate safely on the surface awaiting operation;
a manual operation unit 2 configured to start a manual mode, and set a manual operation starting point and a manual operation ending point on the surface awaiting operation; control the operation robot to perform a preset manual operation from the manual operation starting point, continuously record path information and environmental information during an operation process of the operation robot until reaching the manual operation ending point, and end the manual mode;
an automatic operation unit 3 configured to start an automatic mode, fit an enclosed area of any shape based on the path information and environmental information recorded in the manual mode, plan an automatic operation path within the enclosed area, and use a boundary of the enclosed area as a safety boundary; and control the operation robot to perform an automatic operation within the safety boundary according to the automatic operation path until an operation covering the enclosed area is completed, and end the automatic mode; and
a detection unit 4 configured to check an operation effect and an area coverage effect of the surface awaiting operation.

The automatic operation unit 3 is further configured to: after the operation covering the enclosed area is completed, control the operation robot to automatically return to the manual operation ending point or the manual operation starting point, and notify a user that the automatic operation is completed; and/or during the automatic operation, control the operation robot to detect, through a preset sensing apparatus, whether there are obstacles in a forward direction; and if yes, control the operation robot to automatically avoid the obstacles; and/or infer obstacles on the surface awaiting operation based on the environmental information recorded in the manual mode, and ensure that the planned automatic operation path avoids the obstacles.

In a specific embodiment, the detection unit is further configured to: if the operation effect or the area coverage effect of the surface awaiting operation does not meet an expected value, control the operation robot to perform a manual operation.

This embodiment proposes a robot operation planning system, which systematizes the robot operation planning method of Embodiment 1, making it more practical.

### Embodiment 3

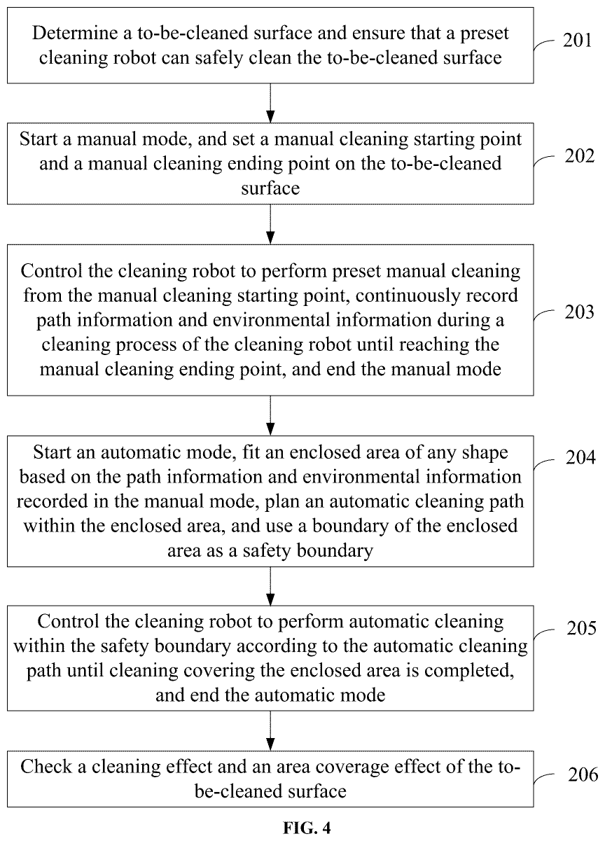

Embodiment 3 discloses a cleaning method, which applies the robot operation planning method of Embodiment 1 to the cleaning field. The flowchart of the cleaning method is shown in FIG. 4, and the specific solutions are as follows:

A cleaning method, which adopts the robot operation planning method of Embodiment 1, includes:
201: Determine a to-be-cleaned surface and ensure that a preset cleaning robot is able to safely clean the to-be-cleaned surface.
202: Start a manual mode, and set a manual cleaning starting point and a manual cleaning ending point on the to-be-cleaned surface.
203: Control the cleaning robot to perform preset manual cleaning from the manual cleaning starting point, continuously record path information and environmental information during a cleaning process of the cleaning robot until reaching the manual cleaning ending point, and end the manual mode.
204: Start an automatic mode, fit an enclosed area of any shape based on the path information and environmental information recorded in the manual mode, plan an automatic cleaning path within the enclosed area, and use a boundary of the enclosed area as a safety boundary.
205: Control the cleaning robot to perform automatic cleaning within the safety boundary according to the automatic cleaning path until cleaning covering the enclosed area is completed, and end the automatic mode.
206: Check a cleaning effect and an area coverage effect of the to-be-cleaned surface.

The present disclosure provides a robot operation planning method and system, and use thereof. Before the robot performs the automatic operation, the area for the automatic operation is determined based on a work trajectory of the manual operation, implementing an alternative mode of map creation to complete the deployment phase of the robot. Compared to the prior art, this method eliminates the need for specialized and cumbersome deployment processes such as mapping, editing, and path setting, as well as complex operation processes such as task selection, position confirmation, and task initiation. It allows for the coverage of most edge operation areas, enhancing the edge operation capability of the robot while ensuring safety. This method fully leverages the advantages of human-robot collaborative operation.

Those skilled in the art should understand that the drawings are only schematic diagrams of a preferred implementation scenario, and the components in the drawings are not necessary for implementing the present disclosure. Those skilled in the art may understand that the modules of the apparatus in the implementation scenario can be distributed in the apparatus in the implementation scenario according to the description in the embodiment, or can be changed accordingly and located in one or more apparatuses different from the implementation scenario.

In this specification, specific examples are used to describe the principle and implementations of the present disclosure, and the description of the foregoing embodiments is only intended to help understand the method and core idea of the present disclosure. Meanwhile, those of ordinary skill in the art may, based on the idea of the present disclosure, make modifications with respect to the specific implementations and the application scope. Therefore, the content of this specification shall not be construed as a limitation to the present disclosure.

Embodiments of the present disclosure are described above with reference to the accompanying drawings, but the present disclosure is not limited to the above specific implementations. The above specific implementations are only illustrative and not restrictive. Those of ordinary skill in the art may make modifications to the present disclosure without departing from the purpose of the present disclosure and the scope of protection of the claims, but these modifications should all fall within the protection of the present disclosure.

What is claimed is:

1. A robot operation planning method, comprising:
determining a surface awaiting operation and ensuring that a preset operation robot is able to operate safely on the surface awaiting operation;
starting a manual mode, and setting a manual operation starting point and a manual operation ending point on the surface awaiting operation;
controlling the operation robot to perform a preset manual operation from the manual operation starting point, continuously recording path information and environmental information during an operation process of the operation robot until reaching the manual operation ending point, and ending the manual mode;
starting an automatic mode, fitting an enclosed area of any shape based on the path information and the environmental information recorded in the manual mode, planning an automatic operation path within the enclosed area, and using a boundary of the enclosed area as a safety boundary;
enabling the operation robot to perform an automatic operation within the safety boundary according to the automatic operation path until an operation covering the enclosed area is completed, and ending the automatic mode; and
checking an operation effect and an area coverage effect of the surface awaiting operation.

2. The robot operation planning method according to claim 1, wherein after the operation covering the enclosed area is completed, the operation robot is controlled to automatically return to the manual operation ending point or the manual operation starting point, and a user is notified that the automatic operation is completed.

3. The robot operation planning method according to claim 1, wherein if the operation effect or the area coverage effect of the surface awaiting operation does not meet an expected value, the operation robot is controlled to perform a manual operation.

4. The robot operation planning method according to claim 1, wherein obstacles on the surface awaiting operation are inferred based on the environmental information recorded in the manual mode, and by combining the safety boundary, the planned automatic operation path avoids the obstacles without entering an area outside the safety boundary.

5. The robot operation planning method according to claim 1, wherein during the automatic operation, the operation robot detects, through a preset sensing apparatus, whether there are obstacles in a forward direction; and if yes, the operation robot is controlled to automatically avoid the obstacles, and the operation robot always stays within the safety boundary during an obstacle avoidance process.

6. The robot operation planning method according to claim 1, wherein the operation robot comprises a floor cleaning robot, a floor washing robot, a lawn mowing robot, a snow sweeping robot, and an inspection robot.

7. A robot operation planning system, comprising:
a preparation unit configured to determine a surface awaiting operation, and ensure that a preset operation robot is able to operate safely on the surface awaiting operation;
a manual operation unit configured to start a manual mode, and set a manual operation starting point and a manual operation ending point on the surface awaiting operation; and
control the operation robot to perform a preset manual operation from the manual operation starting point, continuously record path information and environmental information during an operation process of the operation robot until reaching the manual operation ending point, and end the manual mode;
an automatic operation unit configured to start an automatic mode, fit an enclosed area of any shape based on path information and environmental information recorded in the manual mode, plan an automatic operation path within the enclosed area, and use a boundary of the enclosed area as a safety boundary;
control the operation robot to perform an automatic operation within the safety boundary according to the automatic operation path until an operation covering the enclosed area is completed, and end the automatic mode; and
infer obstacles on the surface awaiting operation based on the environmental information recorded in the manual mode, and by combining the safety boundary, ensure that the planned automatic operation path avoids the obstacles without entering an area outside the safety boundary; during the automatic operation, control the operation robot to detect, through a preset sensing apparatus, whether there are obstacles in a forward direction; and if yes, control the operation robot to automatically avoid the obstacles, and ensure that the operation robot always stays within the safety boundary during an obstacle avoidance process; and the sensing apparatus collects path information and environmental information in the manual mode; and
a detection unit configured to check an operation effect and an area coverage effect of the surface awaiting operation.

8. The robot operation planning system according to claim 7, wherein the automatic operation unit is further configured to:
after an operation covering the enclosed area is completed, control the operation robot to automatically return to the manual operation ending point or the manual operation starting point, and notify a user that an automatic operation is completed; and/or
during the automatic operation, control the operation robot to detect, through the preset sensing apparatus, whether there are obstacles in the forward direction; and if yes, control the operation robot to automatically avoid the obstacles; and/or
infer obstacles on the surface awaiting operation based on the environmental information recorded in the manual mode, and by combining the safety boundary, ensure that the planned automatic operation path avoids the obstacles without entering an area outside the safety boundary.

9. The robot operation planning system according to claim 7, wherein the detection unit is further configured to:
if the operation effect or the area coverage effect of the surface awaiting operation does not meet an expected value, control the operation robot to perform a manual operation.

10. A cleaning method, adopting the robot operation planning method according to claim 1, and comprising:
determining a to-be-cleaned surface and ensuring that a preset cleaning robot is able to safely clean the to-be-cleaned surface;
starting a manual mode, and setting a manual cleaning starting point and a manual cleaning ending point on the to-be-cleaned surface;
controlling the cleaning robot to perform preset manual cleaning from the manual cleaning starting point, continuously recording path information and environmental information during a cleaning process of the cleaning robot until reaching the manual cleaning ending point, and ending the manual mode;
starting an automatic mode, fitting an enclosed area of any shape based on the path information and the environmental information recorded in the manual mode, planning an automatic cleaning path within the enclosed area, and using a boundary of the enclosed area as a safety boundary;
controlling the cleaning robot to perform automatic cleaning within the safety boundary according to the automatic cleaning path until cleaning covering the enclosed area is completed, and ending the automatic mode; and
checking a cleaning effect and an area coverage effect of the to-be-cleaned surface.

11. The cleaning method according to claim 10, wherein after the operation covering the enclosed area is completed, the operation robot is controlled to automatically return to the manual operation ending point or the manual operation starting point, and a user is notified that the automatic operation is completed.

12. The cleaning method according to claim 10, wherein if the operation effect or the area coverage effect of the surface awaiting operation does not meet an expected value, the operation robot is controlled to perform a manual operation.

13. The cleaning method according to claim 10, wherein obstacles on the surface awaiting operation are inferred based on the environmental information recorded in the manual mode, and by combining the safety boundary, the planned automatic operation path avoids the obstacles without entering an area outside the safety boundary.

14. The cleaning method according to claim 10, wherein during the automatic operation, the operation robot detects, through a preset sensing apparatus, whether there are obstacles in a forward direction; and if yes, the operation robot is controlled to automatically avoid the obstacles, and the operation robot always stays within the safety boundary during an obstacle avoidance process.

15. The cleaning method according to claim 10, wherein the operation robot comprises a floor cleaning robot, a floor washing robot, a lawn mowing robot, a snow sweeping robot, and an inspection robot.
